(19) United States
(12) Patent Application Publication
(10) Pub. No.: US 2008/0250463 A1
(43) Pub. Date: Oct. 9, 2008

(54) DIGITAL BROADCAST RECEIVER

(75) Inventors: Toru SHIBUSAWA, Osaka (JP); Kiyoshi MATSUMOTO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/099,529

(22) Filed: Apr. 8, 2008

(30) Foreign Application Priority Data
Apr. 9, 2007 (JP) 2007-101740

(51) Int. Cl. H04N 7/18

(52) U.S. Cl. 725/75

(57) ABSTRACT

A digital broadcasting receiver is equipped with: either at least one lookup table of positive and negative weighted BER factors each assigned to one of predetermined classes of BER of a receivable broadcast signal or a function for deriving said weighted BER factors; at least one counter adapted to classify measured values of BER of the broadcast signal received, obtain BER factors assigned to the measured values, and add up said weighted BER factors as BER is measured at regular time intervals; and control means for controlling said switching means based on the count of said counter, thereby generating proper switching timing for switching broadcast layers in response to the varying reception status of the broadcast signal. As a result, in switching the layers to be presented, frequent switching of the layers can be suppressed while preventing disturbances in video and audio caused by reception errors. The receiver can easily manage holding time for holding the current layer as it is prior to a switching.

### FIELD OF THE INVENTION

This invention relates to a digital broadcasting receiver, and more particularly, to a mobile digital broadcasting receiver for use as an in-vehicle receiver, for example.

### BACKGROUND OF THE INVENTION

In the ISDB-T (Integrated Services Digital Broadcasting Terrestrial) system, which is a digital broadcasting standard currently adopted in Japan, one physical channel can be divided into at most 3 layers each having different modulation frequency so that multiple programs can be broadcasted on one channel. For example, a broadcast signal mainly for fixed receivers is transmitted using a modulation scheme that has a large transmission capacity, and necessary parameters and segments to transmit high quality video and sound data with a high carrier/noise (C/N) ratio. On the other hand, a broadcast signal intended mainly for mobile receivers can be transmitted using a modulation scheme that has such a low transmission rate, parameters, segments as necessary to transmit low quality video and audio data receivable with a required C/N ratio.

Specifically, in the current ISDB-T system, one physical channel consisting of 13 segments each having particular modulation parameters, whereby one physical channel can be divided into at most three layers. Currently, one channel band is divided into a 12-segment layer (hereinafter 12-seg layer) and a 1-segment layer (hereinafter referred to as 1-seg layer), and both layers are mostly used to broadcast the same program.

A broadcast utilizing a 12-seg layer (hereinafter referred to as 12-seg broadcast) is mainly for fixed receivers. This broadcast scheme has a large transmission capacity adequate for transmitting a high quality video, but is required to have a required C/N ratio. The latter broadcast utilizing 1-seg layer (hereinafter referred to as 1-seg broadcast) has a low transmission capacity, and is used to broadcast low quality video that can be received mainly by mobile receivers with a required C/N ratio.

A viewer can switch the receiver between two presented layers depending on the reception statuses of the two layers. He may like to receive as high quality audio and video as possible, or like to view video without frequent switching of layers or without seeing much block noise on the display screen caused by reception errors.

In the case of a receiver utilizing a digital demodulator, error correction becomes drastically difficult as demodulation errors increases beyond a certain bit error rate (BER), and video and audio baseband signals breaks up into noise. In receiving a broadcast wave by a mobile receiver in motion, reception condition of a broadcast wave is influenced by the distance to the transmission station, nearby geography, buildings, multi-path interference, and fading of the wave, so that the reception condition changes at every moment.

Normally, 1-seg broadcast (carried by a lower layer) intended for mobile receivers employs a modulation scheme having such a required C/N ratio and parameters as necessary for reception by mobile receivers. 1-seg broadcast has a larger service area than 12-seg broadcast (carried by a higher layer), and is receivable by a receiver in areas where its electric field is weak. However, video and audio quality of 1-seg broadcast is low, since its transmission rate is low. In contrast, 12-seg broadcast generally has a high transmission rate and enables reception of high quality video on one hand, but on the other hand has a narrower service area than 1-seg broadcast and is easily affected by the reception environment of the receiver. Therefore, it would be convenient to present a 12-seg broadcast at a place where its reception condition is favorable, and switch to 1-seg broadcast at a place where reception condition is poor. However, frequent switching between 1-seg broadcast and 12-seg broadcast would make the viewer very unpleasant.

Conventionally, switching of receiver between two broadcast layers is executed when at least one index indicative of the quality of a broadcast signal such as the reception power level, C/N ratio, BER, and the amount of block noise have exceeded a predetermined level. (See, for example, Japanese Patent Application Laid Open Nos. 2005-277873 and 2005-223549.)

However, cumbersome switching can take place too often and bothers the viewer if switching solely depends on whether such parameter as the reception power, C/N ratio, BER, or block noise has exceeding predetermined levels. To circumvent such inconvenience, multiple thresholds may be set for a parameter. Since implementation of multiple thresholds will result in hysteresis in the switching, the switching will become less frequent as compared with the switching controlled by a single threshold. However, since this implies that the switching will not start right away (that is, the receiver will not promptly switch to the lower layer having a low bit rate and a required C/N ratio) if the reception condition has become poor, there can be a period where no video or audio is presented on the display until the switching is executed. Further, the layer will not be instantly switched over to the higher layer (having a required C/N ratio and a high bit rate) right after the reception condition has improved.

As disclosed in, for example, Japanese Patent Application Laid Open No. 2005-277873, BER can be used as the quality index indicative of reception condition of a signal received. In this approach switching is based on the comparison of the BER value of each segment with a preset BER value. As a consequence, frequent switching of layers can still occur, though the switching frequency may be reduced depending on the reception condition.

In order to make an accurate measurement of BER, a certain period of time is necessary. Usually, transmission rates of 12-seg broadcast and of 1-seg broadcast are different and, if the measurement times are the same for the two broadcast waves, the accuracy of the BER of 1-seg broadcast can be poorer than that of 12-seg broadcast by 2 orders of magnitude, so that measured values of BER of the two broadcast waves cannot be compared in a simple manner. Further, although the precision of BER values can be improved by measuring the BER for a sufficiently long time, BER is not an advantageous and practical quality index of a signal in an environment where reception condition changes quickly with time.

Japanese Patent Application Laid Open No. 2005-223549 discloses use of the S/N ratio of a signal received as the quality index of the signal, in which a hysteresis is set up in the switching of layers from “A” layer (lower layer) to “B” layer (higher layer) by setting different thresholds for the S/N ratio before and after the switching. In the cited reference, the moving average of the S/N ratio is also considered as decisive information for making a switching. However, immediately after a switching from B layer to A layer as set off by the S/N ratio being less than 20 dB for example, the moving average of the S/N ratio is not taken into account and A layer is soon switched over to B layer if the S/N ratio exceeds 24 dB and BER is less than 1e-3 (10⁻³), as seen from the chart shown in FIG. 2 of the above-cited reference. Such frequent switching from A to B and from B to A layer as stated above could be avoided if the measurement period is sufficiently long (though the period is not described in the reference). But, such long measurement time will delay switching the receiver from B layer to A layer even when the reception condition has become poor, so that either noisy video (audio) or no video (audio) will be presented until B layer is switched over.

### SUMMARY OF THE INVENTION

In view of these problems pertinent to prior art receivers, it is an object of the present invention to provide a digital broadcasting receiver capable of presenting a desired program data carried by switchable layers while preventing frequent switching of the layers and disturbances in video and audio caused by switching of layers, and capable of easily managing a period of holding time for holding the current layer as it is prior to switching.

To this end, there is provided in accordance with one aspect of the invention a digital broadcasting receiver having switching means for switching said receiver between different received layers of a broadcast channel broadcasting a digital broadcast program, in accordance with the reception statuses of said layers, said receiver comprising:

either at least one lookup table of classified positive and negative weighted BER factors each assigned to a predetermined range of BER of a receivable broadcast signal or a function for deriving said weighted BER factors;

at least one counter adapted to add up the weighted BER factors that are found by the lookup table and/or the function in correspondence with the measured values of BER of a received broadcast signal as measured at predetermined time intervals;

control means for controlling said switching means based on the count of said counter;

thereby generating appropriate switching timing for said switching means.

In the invention, the receiver is adapted to: measure the value of BER at predetermined regular time intervals (at every 1 second for example); obtain a corresponding weighted BER factor for the measured BER value by looking up the lookup table of weighted BER factors each BER factor assigned to a predetermined range of classified BER values; and add up the BER factors thus obtained to the count of the counter to determine timing of switching. In this case, the BER factors in a low BER range and in a high BER range can be weighted in such a way that the time required for the receiver to switch from the higher layer (12-seg layer) to the lower layer (1-seg layer) and the time for reverse switching are asymmetric, thereby allowing the 12-seg layer to be switched over to the 1-seg layer rather quickly when BER has suddenly become poor but allowing the converse switching to take place only after a certain period of time when BER is gradually improving, thereby facilitating suppression of frequent switching of the layers.

With the above-described configuration of the lookup table, it is possible to control the switching time to switch the layers in accord with the reception statuses such that layers are switched without incurring significant disturbance in video and audio, even while receiving a program by, for example, an in-vehicle mobile receiver under a quickly varying reception condition. It should be appreciated that since the switching timing can be changed by simply altering classes of BER and such parameters of a lookup table as BER factors and the allowable maximum count, the counter and the lookup table can be easily incorporated in a reception control software, and that a viewer can easily set the switching timing for his preferences.

In this arrangement, an allowable maximum count for the counter is preliminarily set in said lookup table, and said control means may be adapted to:

measure BER at predetermined time intervals;

add a BER factor associated with the measured value of BER to the count of said counter;

reset said count to zero if said count becomes less than zero when said factor is added to said count, and perform switching from one layer to another only if the latest layer is not the same as the layer that would be presented by said switching; and

hold said count to said allowable maximum count if said count exceeds said allowable maximum count when said factor is added to said count, and perform switching from one layer to another only if the latest layer is not the same as the layer that would be presented by said switching.

With this control means, the above-described results of the invention can be easily achieved.

The initial count of the counter is preferably set to a value less than said allowable maximum count.

With the initial count set to a value less than the allowable maximum count, when the receiver is turned on or when the reception condition is not favorable, the count can reach zero quickly, thereby allowing switching from the higher layer (12-seg broadcast) to the lower layer (1-seg broadcast) in a short period of time.

The receiver is preferably provided with a multiplicity of different counters that operate in parallel to each other in association with a respective lookup table of weighted BER factors having an allowable maximum count for that counter, wherein said control means is adapted to perform switching between said layers when the count of a particular one of said multiple counters has exceeded a predetermined value and when the count of another counter satisfies predetermined criteria.

In this configuration, when the reception condition has becomes worse, the receiver is promptly switched from the higher (1-seg) layer to the lower (12-seg) layer based on the count of a particular counter. On the other hand, when the reception conditions has improved, the receiver is switched back to the 12-seg layer faster upon referencing the count of another counter than referencing the count of said particular counter.

The receiver may be provided with a multiplicity of counters and a multiplicity of different lookup tables having different allowable maximum counts in associated with the respective multiple counters, so that the viewer or operator of the receiver can select a preferred one of the lookup tables for a preferred mode of switching of the layers.

Thus, the viewer can select by choice a stability enhancement mode say in which the receiver is automatically switched to the lower (1-seg) layer and maintain the receiver in a stable reception condition as soon as the reception status becomes worse, or a resolution enhancement mode in which the higher (12-seg) layer is maintained as long as possible to present high resolution video irrespective of, for example, some block noise causing some signal errors.

In the case of a receiver installed on a vehicle, the receiver may be provided with a multiplicity of different lookup tables having different allowable maximum counts for the counters, so that the control means may select a preferred lookup table having preferred BER factors and an allowable maximum count in accordance with the position and velocity information on the vehicle.

In this configuration, in the vehicle that is stopped or moving at a low speed, the receiver can establish a dynamic switching of layers in which the higher (12-seg) layer can be maintained by selecting a lookup table having a preferred combination of BER factors and an allowable maximum count that allow holding of video and audio of the 12-seg layer even when there is only a small error-free margin in BER. This is true when the vehicle is stopped or moving at a speed lower than a normal speed, since the reception condition then remains stable and fading is much less, and so is abrupt changes in BER.

It is preferable to define the minimum holding time for holding the current layer as it is prior to a switching, based on a relationship between the period of measuring BER, the allowable maximum count, and the minimum and maximum BER factors of a lookup table. In this case, it is preferable to set the upper count limit such that the absolute value of the quotient obtained by dividing said allowable maximum count by said minimum BER factor is greater than the quotient obtained by dividing said allowable maximum count by said maximum BER factor.

Thus, the minimum holding time for holing the lower (1-seg) layer as it is before it is switched over to the higher (12-seg) layer and the minimum holding time for holding the lower (1-seg) layer as it is before it is switched over to the higher (12-seg) layer are asymmetrical. As a consequence, switching from the higher (12-seg) layer to the lower (1-seg) layer can be made less probable than the reverse switching.

The lookup table preferably has a range of zero BER factors between the positive and negative BER factors.

Since such zero BER factors will not change the count of the counter if the value of BER varies in the range of zero BER factors, they provide a further switching hysteresis along with the hysteresis that arises from asymmetry of the weighted BER factors, so that the receiver advantageously has a double-hysteresis structure.

### BRIEF DESCRIPTION OF THE DRAWINGS

FIG. 1 is a block diagram showing an arrangement of an in-vehicle digital terrestrial broadcasting receiver in accordance with one embodiment of the invention.

FIG. 2 is a flowchart illustrating a layer switching program in accordance with the embodiment.

FIG. 3 illustrates variations in BER and corresponding variations in the counts of counters.

FIG. 4 illustrates another example of variations in BER and corresponding variations in the counts of counters.

FIG. 5 is a comprehensive illustration of the variations in the counts of the main counter and sub-counter.

FIG. 6 is a flowchart of an alternative layer switching program.

### DETAILED DESCRIPTION OF THE PREFERRED EMBODIMENT

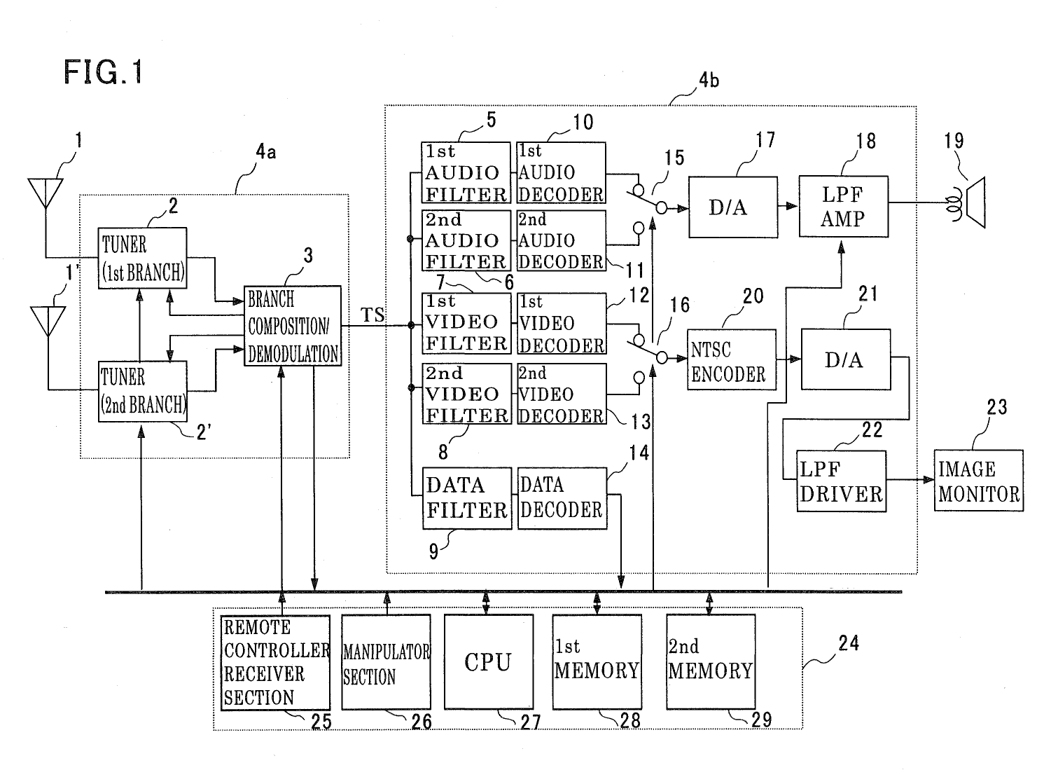

Referring to the accompanying drawings, the invention will now be described in detail by way of example with reference to a particular in-vehicle digital terrestrial broadcasting receiver. Referring to FIG. 1, there is shown in block diagram an in-vehicle digital terrestrial broadcasting receiver in accordance with one embodiment of the invention.

In an in-vehicle receiver, it is customary to have a multiplicity of antennas for space diversity reception in order to enhance the reception performance of the receiver. In the example shown herein, the receiver is provided with two antennas 1 and 1′ respectively connected to tuners 2 and 2′ that can be tuned to particular physical channels. The antennas 1 and 1′ and tuners 2 and 2′ constitute a first and a second tuning branch as shown. The antennas 1 and 1′ are spaced apart on the body or windows of the car as they are installed. The tuners 2 and 2′ are tuned to the same physical channel.

The signals selected by the respective tuners 2 and 2′ are fed to an OFDM (Orthogonal Frequency Division Multiplexing) demodulator 3. The OFDM demodulator 3, constituting a front end section 4a together with the tuners 2 and 2′, composes multiple carries of the signal received in the respective branches, and then performs layer division, frequency-time de-interleaving, Viterbi decoding, and RS (Read Solomon) decoding of the signal to generate a TS (Transport stream) of data that is fed to the back-end section 4b of the receiver. It is noted that in the case of a fixed receiver, reception can be achieved by a single reception system.

In the back-end section 4b, TS packets pass through a first and a second filters 5 and 6, respectively, a first and a second video filters 7 and 8, respectively, and a data filter 9 to extract audio, video, and data packets, which are then decoded by a first and a second audio decoder 10 and 11, respectively, a first and a second video decoder 12 and 13, respectively, and a data decoder 14. The decoder 14 decodes system control information data and send it to a CPU (Central Processing Unit) 27 that constitutes control means as described in more detail later.

An audio data selection switch 15 switches the outputs of the first audio decoder 10 and the second audio decoder 11 in response to an instruction received from the CPU 27. A video selection switch 16 switches the outputs of the first and second video decoder 12 and 13, respectively, in response to an instruction also received from the CPU.

An audio D/A (Digital/Analog) converter 17 converts the audio data selected by the audio data selection switch 15 into a baseband audio signal, which is amplified by a low-pass filter-amplifier 18 and outputted from a speaker 19 in the form of sound.

An NTSC encoder (in compliance with National Television Standards Committee standards) 20 converts the video data selected by the video data selection switch 16 into a video signal of NTSC format. The video signal data is further converted into a baseband video signal by a video D/A converter 21, and sent to a video monitor 23 to display the data via a low-pass filter/driver 22.

Upon receipt of an operational command from a remote controller transmitter (not shown), the reception section 25 of a remote controller 24 decode the command and send it to the CPU 27. A manipulator section 26 provided on the casing of the receiver transfers information inputted by a viewer and/or an operator of the receiver to the CPU 27. A first memory 28 is a non-volatile rewritable memory adapted to store a system control program executable by the CPU 27, along with information required to select broadcast stations, information received, and lookup tables of the invention. In controlling the front-end section 4a and the back-end section 4b, the CPU 27 retrieves necessary program data stored in the first memory 28. A second memory section 29 is a RAM serving as a work area for the CPU 27 executing programs.

Referring to FIG. 1, there is shown in flowchart a procedure of controlling signals and switching of layers.

The RF (Radio Frequency) signals received by the antenna 1 and 1′ are fed to the respective tuners 2 and 2′. As the viewer selects a preferred channel via the remote controller or the manipulator section 26, the CPU 27 sends the same PLL (Phase Locked Loop) signal having a given frequency to each of the tuners 2 and 2′ to select the same physical channel. Each of the tuners 2 and 2′ then outputs an IF (Intermediate Frequency) signal to the demodulator 3.

The signals received by the respective antennas 1 and 1′ may have a low power or a required C/N ratio due to the directivities of the antennas and/or the direction of the incident electromagnetic wave relative to the body of the car, or it may be deteriorated by fading due to the motion of the vehicle. In either case, the power level of the wave changes in time. If the broadcast wave has more than one carrier, they can have different C/N ratios not only because the electric fields of the carriers have dissipated in different ways but also because the carriers are affected by multi-path interference. However, since the two antennas of the two tuning branches are mounted at different positions of the vehicle, reception performance of the receiver can be improved better than that of a single antenna if the signals picked up by the two branches are appropriately composed and selected.

It is noted that the two signals picked up by the first and second branches have different instantaneous levels and a certain time correlation, and that reception of a desired signal is possible, if fading has occurred, by weighting the carriers outputted from the two branches and then composing the weighted carriers. The demodulator 3 demodulates the signal obtained by the composition of the two signals from the two branches and outputs a demodulated TS.

As stated above, in the digital terrestrial broadcasting system in accord with the ISDB-T standard, one physical channel, or 1 channel band, consists of 13 segments each containing its own modulation parameters, and can be split to at most 3 layers. Currently, however, one channel band is mostly divided into a 12-seg layer and a 1-seg layer to simultaneously broadcast the same program.

The 12-seg broadcast that utilizes the 12-seg layer is intended mainly for fixed receivers, since the layer has a large transmission capacity and can provide a high quality video. But it requires a required C/N ratio. The 1-seg broadcast that utilizes the 1-seg layer is intended mainly for mobile receivers. It may have a required C/N ratio, but has a low transmission capacitor, so that it can provide only low quality video. In the case of an in-vehicle receiver, the program can be viewed without interruption by automatically switching the receiver by means of the back-end section 4b to the 12-seg broadcast where the electric field has a favorable intensity, and switching to the 1-seg broadcast where the electric field is poor.

Specifically, the TS outputted from the front-end section 4a is fed to the respective filters 5-9 of the back-end section 4b, so that the it is separated into encoded audio signals of 12-seg and 1-seg layers by the first and second audio filter 5 and 6, respectively, and into encoded video signals of 12-seg and 1-seg layers by the first and second video filters 7 and 8, respectively. The encoded audio and video signals of the respective layers are then simultaneously decoded by the first audio decoder 10 (for 12-seg layer) and by the second audio decoder 11 (for 1-seg layer), and by the first video decoder (for 12-seg layer) and the second video decoder 13 (for 1-seg layer). The CPU 27 selects audio and video signals to be presented by selecting the decoded data using the selection switches 15 and 16 at a given switching timing. This switching timing is generated by a procedure (described below) based on the values of BER of Viterbi-decoded output of the demodulator 3.

The audio data of the 12-seg layer or 1-seg layer is selected by the audio selection switch 15, converted to a baseband audio signal by the audio D/A converter 17, limited in band and amplified by the low-pass filter 18, and then outputted from the speaker 19 in the form of sound.

The video data of the 12-seg layer or 1-seg layer is selected by the video selection switch 16, converted to NTSC format by the NTSC encoder 20, further converted to a baseband video signal by the video D/A converter 21, limited in band by the low-pass filter/driver 22, and then sent to the activated video monitor 23 to be displayed on the video monitor 23.

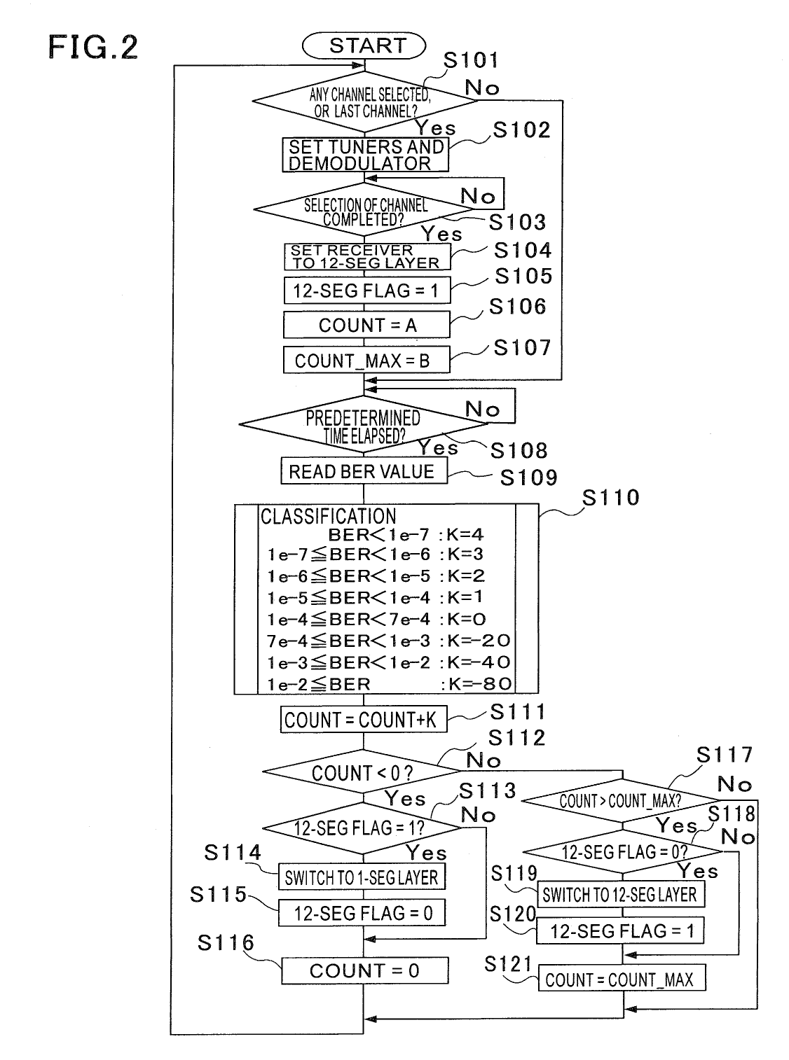

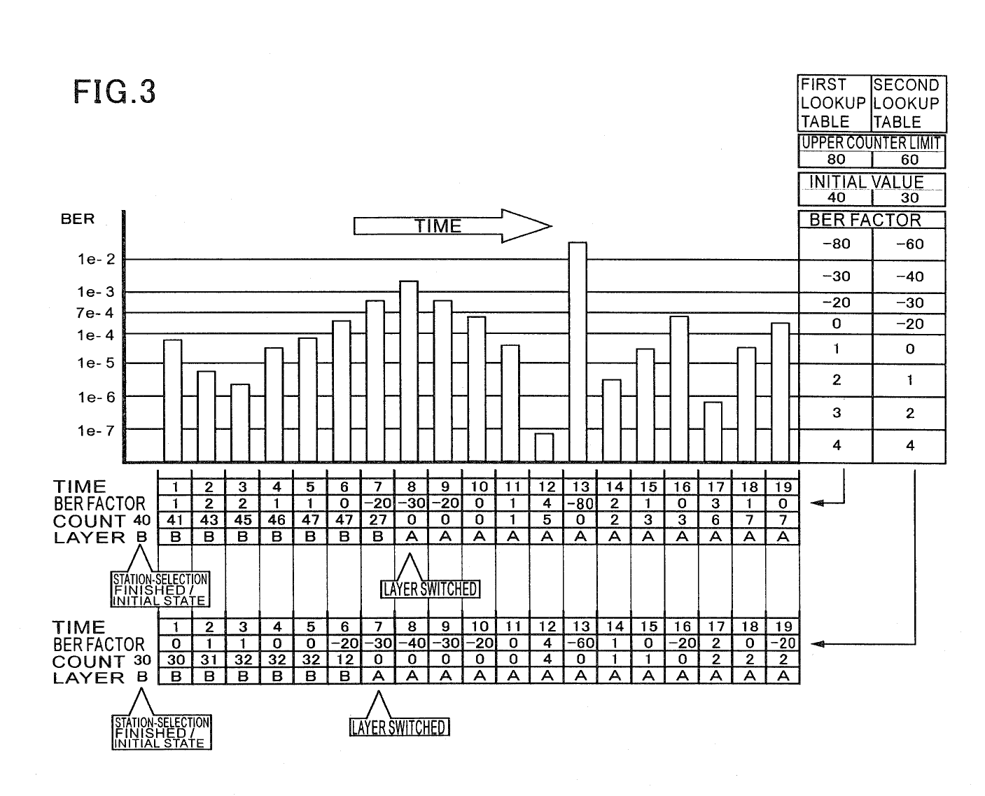

Next, referring to FIGS. 2 and 3, a process of generating switching timing for switching the layers in accordance with one embodiment of the invention will now be described. It is assumed that a certain channel is receivable for the receiver. FIG. 2 is a flowchart of a layer switching program executed by the CPU 27. FIG. 3 illustrates how the count of the counter changes with the change in BER. In FIG. 3, reference is made to a first and a second lookup tables, but the flowchart of FIG. 2 refers only to the first lookup table.

In FIG. 2, the flowchart begins with “Start”, at which stage the receiver remembers the last channel (i.e. channel selected last time), and is in a standby condition waiting for a selection of a channel by the viewer.

When the viewer turns on the power switch (not shown) of the manipulator section 26, the CPU 27 selects the last channel (step S101) and sends frequency setting data to the tuners 2 and 2′ (step S101) and setting data to the demodulator 3 to select the last channel (step S102).

Step S103 for determining the selection of a channel is repeated until a normally demodulated data and a TS is outputted following the selection of a channel in step S102. As the receiver is properly activated to receive a broadcast and starts generating normal TS packets, the CPU 27 switches the video data selection switch 16 to the first video decoder 12 (e.g. MPEG2 decoder) and switch the audio data selection switch 15 to the first audio decoder 10 in step S104, thereby providing 12-segment video and audio data to the display (where MPEG-2 is a compression standard for encoding high-definition moving pictures and associated audio data in a format suitable for storage on a storage medium). In step S105, a 12-seg flag is set to 1. In step S106, an initial value A and an allowable maximum count B are set for the counter (where A=40 and B=80 in the example shown).

As BER of the signal is measured at regular time intervals of 1 second say, for simplicity, step S108 is looped back to itself for 1 second, after which BER is measured in step S109. The measurement is done by the CPU 27 by reading out the value of a particular register. In the example shown in FIG. 2, step S108 is repeated by a loop, but the loop may be substituted for by appropriate timer interrupts.

In step S110, the value of BER measured in step S109 is classified to obtain a corresponding BER factor K. For example, when the reception condition is favorable and the Viterbi-decoded signal has BER equal to 3e−6, then K=2. But when the reception condition is not so good that BER equals to 9e−4, then K=−20, where “e” represents the base 10 of common logarithm (not natural logarithm), and the numbers −6 and −4 above are the powers of e. Therefore, 3e−6 actually equals to 3×10⁻⁶, and represents values X in the range

1e−≦X<1e−5.

The value of K is added to the count of the counter in step Sill. In step S112, a determination is made as to whether the count is less than zero or not. If it is, it implies that the reception condition is poor, which causes the procedure to proceed to step S113. If the currently presented data belongs to the 12-seg layer with the 12-seg flag set to 1 in step S113, then in step S114 the CPU 27 switches the data selection switches 15 and 16 to the second audio decoder 11 and second video decoder 13 (e.g. H.264 decoder), respectively, to present the 1-seg broadcast video and audio. (H.264 is a standard for video compression to allow a moving picture to be transmitted in a reduced data size.) Subsequently, in step S115, the 12-seg flag is reset to zero and the counter is reset to the lowest possible value 0. If the 12-seg flag is zero in step S113, implying that the current data belongs to the 1-seg layer, then the procedure proceeds to step S116 to reset the count of the counter to the lowest possible value zero without performing switching and returns to step S101.

On the other hand, if the count is found to be equal to or greater than zero in step S112, then in step S117 the count is checked whether it exceeds the upper count limit. If it does, it implies that the receiver has a favorable reception status. Then, the procedure proceeds to step S118, where it is found that the 12-seg flag has been set to zero if the currently presented data belongs to 1-seg layer. Then, the procedure proceeds to step S119, where the data selection switches 15 and 16 are switched to the first audio decoder 10 and the first video decoder 12, respectively, for the 12-seg layer as instructed by the CPU 27, and further in step S120 the 12-seg flag is set to 1, and the counter is set to the maximum possible value, i.e. allowable maximum count, in step S121, after which the procedure returns to step S101. If in step S118 the 12-seg flag is 1, it implies that the current data belongs to the 12-seg layer. Then the procedure proceeds to step S121 without performing switching. In step S121, the procedure sets the counter to the allowable maximum count and then returns to step S101. On the other hand, if the answer is NO in step S117, it implies that the counter has a value between the allowable maximum count and zero. Then the procedure returns to step S101 without performing anything.

In the above procedure, measurement of BER, derivation of factors, and addition of BER factors to the counter are performed at predetermined time intervals. Switching of layers is executed in accordance with the count of the counter and the status of the current layer.

If a station other than currently selected one is selected, the 12-seg layer of the station is first presented on the display, and after initializing parameters for the layer, a procedure similar to the one as described above is repeated. In this case, by setting the initial value of the counter to a value less than the allowable maximum count, switching of the receiver to the 1-seg layer can be attained in a short period of time in the event that the reception status of the 12-seg layer is not favorable at the startup of the receiver or at a stage a new station is selected, since the counter can then quickly reach zero.

Next, referring to FIG. 3, exemplary time variations of BER of data, associated variations of the count of a counter, and switching timing for the two layers will be explained with reference to two-pattern lookup tables that incorporates BER factors, allowable maximum counts, and initial values of the counters. In FIG. 3 also, expressions such as 1e−2 and 1e−3 obey the same notation rules described in connection with step S110 of FIG. 2. The factors listed in two tables (of “Elapsed Time”, “Factors”, “Counts”, and “Layers”) shown below the BER graph are calculated from the values listed in the table shown on the right side of the BER graph. For example, the value of BER at Elapsed Time No. 13 is larger than 1e−2 (BER>1e−2), to which a BER factor of −80 is assigned in the first lookup table and −60 in the second lookup table. In a similar way, when 1e−3≦BER<1e−2, a BER factor of −30 is assigned to the BER according to the first lookup table and −40 according to the second lookup table; for 7e−4≦BER<1e−3, a factor of −20 is assigned to the BER according to the first lookup table and −30 according to the second lookup table; and so on.

The first lookup table has an allowable maximum count of 80 and an initial value of 40. The left end of the abscissa of the BER graph corresponds to the time immediately after a station is selected. At this stage, data of B-layer (higher 12-seg layer) is presented. One second later, the value of BER of the Viterbi-decoded signal is 7e−5, that is, 1e−5≦BER<1e−4. The BER factor for this BER is found to be 1 in the first lookup table, so that 1 is added to the initial value 40 of the counter, resulting in the count of 41. Similarly, as BER becomes 6e−6 a further second later, the assigned BER factor of 2, found in the first lookup table, is added to the current count of 41, which makes the count 43. Measurement of BER and addition of factors are repeated in the same manner at predetermined regular intervals. As the reception condition gets worse, the BER becomes worse (larger), but the associated BER factors are positive or zero so long as the errors are correctable. Seven seconds after the selection of the channel, BER becomes so poor that the BER factor is now −20, and the count begins to decrease. BER is still poor at 8 seconds that errors are not correctable any longer, so that errors will appear as noise both in the video and audio. The BER factor is −30 at this stage. If this BER factor is added to the latest count of 27, the resultant count becomes negative. As a consequence, switching of the layer takes place, since the currently presented layer is B-layer. As a result, A-layer (lower layer) is presented. This procedure corresponds to “YES” in step S112 and the subsequent steps S112 through S116. Subsequently, although BER of the broadcast abruptly goes up and down and the BER value improves on the average, the count of the counter remains low compared with the allowable maximum count, at least in the period of time shown in FIG. 3. As a consequence, B-layer will never revive.

In contrast, if the second lookup table having a different allowable maximum count (60) and a different initial value (30) than the first lookup table is used, switching from B-layer to A-layer takes place 1 second earlier than in the preceding example that references the first lookup table. This switching occurs before deteriorated B layer video and audio data are presented on the display.

Switching from (1-seg) A-layer to (12-seg) B-layer also takes place at different timing with the second lookup table than with the first lookup table, though it is not shown in FIG. 3. That is, if the second lookup table is used, such switching takes place at a later time than the case where the first lookup table is used.

In this way, by varying the allowable maximum count, initial value, and BER factors of a lookup table, the layers can be switched over at preferred timing in response to the change in the reception status of data. To do so, weighted BER factors in a low and a high range in the lookup table are asymmetrized in such a way that the time required for a forward switching from the high layer (12-seg layer) to the lower layer (1-seg layer) and the time for a reverse switching are not symmetric, thereby causing the 12-seg layer to be switched over to the 1-seg layer promptly when BER has suddenly deteriorated, but causing the reverse switching to take place only after a certain period of time when BER is gradually improving, thereby facilitating suppression of frequent switching of the layers.

With the above-described configuration of the lookup table, it is easy to control the switching time to switch a layer in accord with the reception status of the layer such that the layer is switched over to another layer without incurring significant disturbance in video and audio data even when receiving a broadcast by an in-vehicle mobile receiver whose reception condition is varying at every moment. It should be appreciated that the switching timing can be changed by simply altering classes of BER and such parameters of a lookup table as BER factors and the allowable maximum count, and that the lookup table can be easily incorporated in a reception control software. Accordingly, a viewer of a mobile receiver can easily set the receiver to suit his preferences.

It is noted that, by classifying and weighting in detail BER values in a region where an error begins to occur, the 12-seg layer can be well maintained up until the last second before a video and audio error begins to occur. Although FIG. 3 illustrates 8 classes of BER values, a more detailed classification and weighting of BER values can be provided.

The ratio of the allowable maximum count to the smallest BER factor of the lookup table corresponds to the shortest time for switching from the 1-seg broadcast to the 12-seg broadcast after a satisfactory improvement in the reception status. For example, as seen in the first lookup table shown in FIG. 3, when the allowable maximum count is 80 and the smallest BER value is 4, the 1-seg broadcast is held for at least 20 seconds if BER is measured 4 times a second. Therefore, frequent cumbersome switching of layers from, for example, 1-seg broadcast to the 12-seg broadcast and then from the 12-seg broadcast to the 1-seg broadcast, will not take place for 20 seconds even if reception status has improved or deteriorated in this period.

Similarly, the ratio of the allowable maximum count to the largest BER factor of the lookup table corresponds to the shortest time for switching from the 12-seg broadcast to the 1-seg broadcast after an unacceptable deterioration of the reception status has occurred. For example, when the allowable maximum count is 80 and the largest BER factor of the lookup table is −80 as in the first lookup table shown in FIG. 3, switching from the 12-seg broadcast to the 1-seg broadcast can take place at least 1 second, and at most 2 seconds, after a measurement of BER if BER is measured 4 times a second. As a consequence, the layer is promptly switched to the 1-seg broadcast without incurring errors or interruptions of the video and audio even when the reception status has abruptly become extremely poor.

Thus, by setting the allowable maximum count and the smallest BER factor such that

Absolute value of (Upper Counter Limit)/(Smallest BER Factor)>

(Upper Counter Limit)/(Largest BER Factor), the minimum holding time for holding the 12-seg layer as it is in the event that it is to be switched over to the 1-seg layer, and the minimum holding time for holding the 1-seg layer as it is in the event that it is to be switched over to the 12-seg layer are asymmetrized in such a way that the switching from the 12-seg layer to the 1-seg layer can take place more easily than the reverse switching.

Further, by providing zero BER factors in the lookup table, the count is kept unchanged if BER changes within that zero BER range, thereby entailing a hysteresis in the switching of layers.

In the example shown above, the time interval of measuring BER is set to 1 second. If the time interval is shortened to less than 1 second, a quicker decision on the switching of layers can be made, but since the accuracy of BER measurement depends on the bit rate and measurement time, the time interval can be shortened within a range that can secure a required precision of BER values measured.

Noting the fact that timing of switching the layers can be altered by altering the allowable maximum count and BER factors in the lookup table, two optional switching modes having different allowable maximum count and/or BER factors can be provided to a viewer. For example, in a stability enhanced mode the 12-seg layer may be promptly switched over to the 1-seg layer as soon as the reception status becomes worse, and in a resolution enhanced mode, the 12-seg layer is maintained so long as presentation of a high-resolution video is possible irrespective of some signal errors arising from block noise.

In the case of a mobile receiver carried on a vehicle equipped with a geolocation system, while the vehicle is moving at a normal speed, the receiver may be set to a dynamic mode in which the allowable maximum count and BER factors of the lookup table are automatically revised in a dynamic fashion based on the speed of the vehicle and position information available to the vehicle, thereby allowing switching of the 12-seg layer to the 1-seg layer at a relatively early stage. On the other hand, when the vehicle is stopped or moving at a low speed, the reception status is relatively stable and little affected by fading, and little abrupt change in BER occurs. Thus, in order to present 12-seg video and audio as long as possible even when there is only a little error-free margin in BER, it is possible to use a lookup table having an allowable maximum count and BER factors that can delay switching of the 12-seg layer until an error occurs in the 12-seg layer.

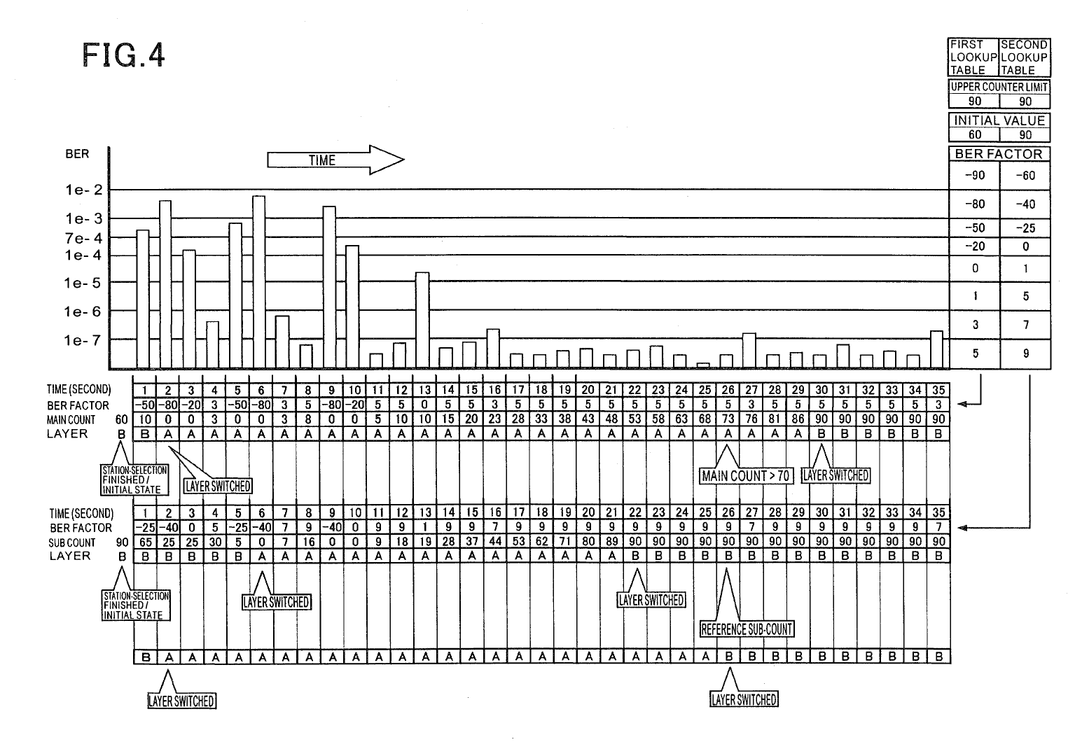

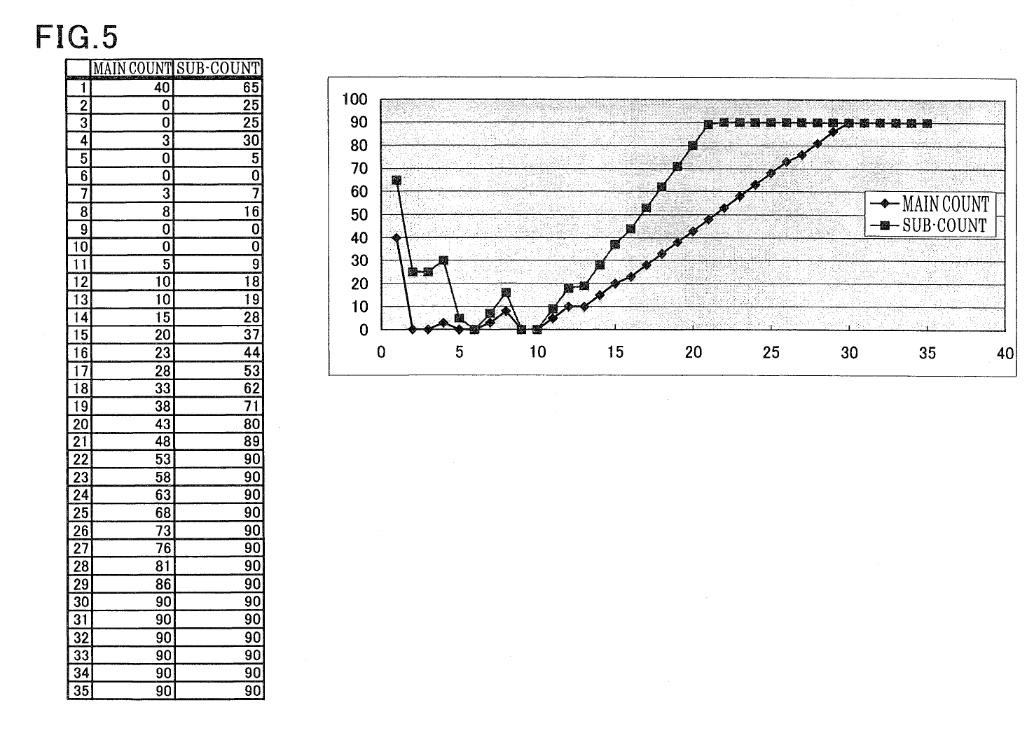

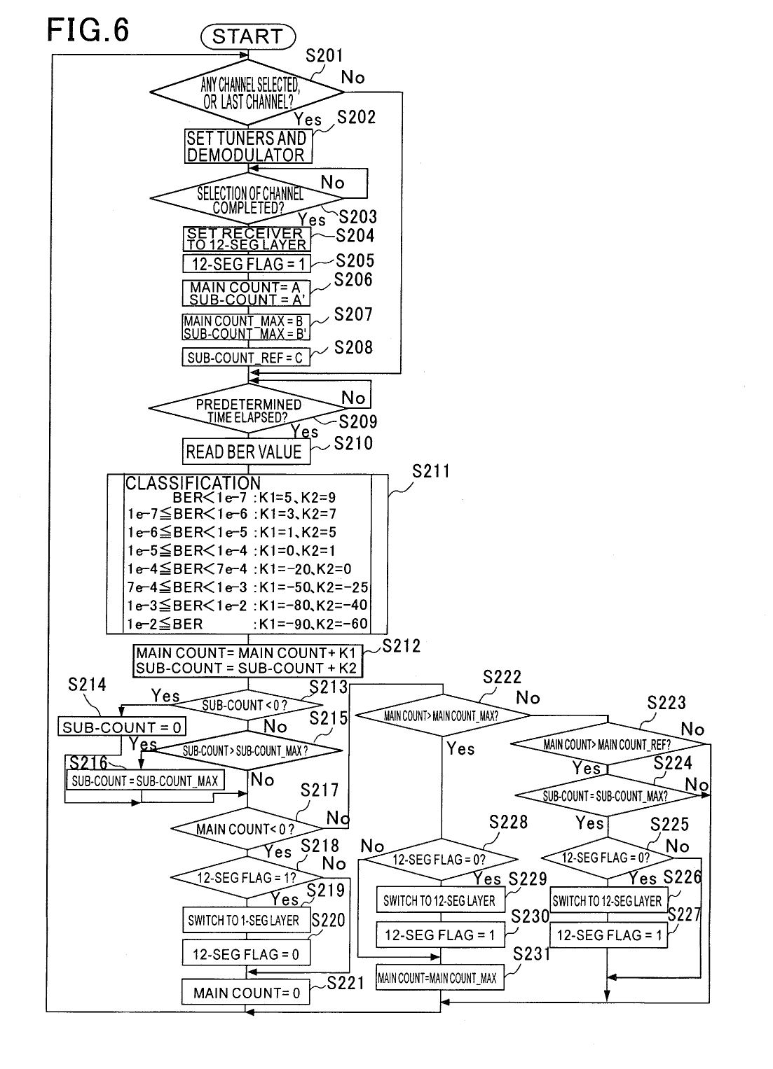

Referring to FIGS. 4, 5, and 6, there is shown another procedure for generating timing for switching the layers in accordance with a second embodiment of the invention. More particularly, FIG. 4 illustrates how the count of the counter changes with BER. FIG. 5 shows variations in the count of a main counter (referred to as main count) and in the count of a sub-counter (referred to as sub-count) in a comprehensive manner. FIG. 6 is a flowchart of another layer switching program. Reference is made again to the block diagram of FIG. 1.

In this embodiment, a first (MAIN) and a second (SUB) counter shown in FIG. 4 are operated independently in parallel to each other. The first and second counters are each adapted to add up BER factors in accordance with the first and second lookup table, respectively.

The first counter tends to perform switching to the 1-seg layer as soon as the reception status of the 12-seg layer becomes worse, but tends to delay switching back to the 12-seg layer if the reception status has improved a little. On the other hand, the second counter performs switching to the 1-seg broadcast only if the reception status becomes worse to a certain degree, but perform switching back to the 12-seg layer sooner than the first counter when the reception status gets improved.

In a preferred mode of switching, the receiver is switched to the 1-seg layer promptly when the reception status gets worse, and switched back to the 12-seg layer when the reception status is improved to a certain degree. In order to enable such switching, the first counter (serving as the main counter) references the count of the second counter (serving as the sub-counter) when the main count exceeds a given threshold (hereinafter referred to as sub-counter reference threshold or SUB-COUNT_REF) set between zero and its allowable maximum count, and, in the event that the sub-count has already exceeded its largest allowable count (referred to as maximum sub-count), the 1-seg layer is switched over to the 12-seg layer.

In the example shown in FIG. 4, if the SUB-COUNT_REF is set to 70, which is below the allowable maximum count of 90 of the first lookup table, the main count exceeds the SUB-COUNT_REF 26 seconds after a station is selected. Upon reference to the sub-counter, the main counter finds that the sub-count has already exceeded the maximum sub-count of 90. Thus, switching takes place from the 1-seg layer to the 12-seg layer.

In contrast, if the main count decreases from the maximum main count to a value below the SUB-COUNT_REF, the main counter does not reference the sub-counter nor make any determination regarding switching.

In this way, in the two-counter system, switching of the receiver from the 12-seg layer to the 1-seg layer is promptly executed when the reception status gets worse, and the reverse switching is executed in a shorter time than that of the receiver utilizing only the first counter.

Referring to the flowchart of FIG. 6, the second switching program will now be described.

In the flowchart shown in FIG. 6, it is assumed that the receiver is in an ordinary reception environment, and that, at the stage of “START”, the receiver is tuned to the “last channel”, prior to a new selection of a channel by the viewer. It is also assumed here that the channel to which the receiver is tuned is receivable.

When the power switch (not shown) of the manipulator section 26 is turned on, the CPU 27 sends frequency setting data to the tuners 2 and 2′ and setting data to the demodulator 3 to select the last channel (step S202 following “YES” in S201).

The step S203 is repeated until a normally demodulated data and a TS are outputted following the selection of the channel in step S202. In step S204, as the receiver is properly activated to receive a broadcast and begins to generate normal TS packets, the CPU 27 switches the video data selection switch 16 to the first video decoder 12 and switches the audio data selection switch 15 to the first audio decoder 10, thereby present 12-seg video and audio on the display. In step S205, a 12-seg flag is set to 1. In step S206, initial values A and A′ and maximum main count B and maximum sub-count B′ are set for the respective counters (where A=60 and A′=90 in the example shown). In step S207, the maximum main count and maximum sub-count of the two counters are both set to 90 (B=B′=90). The SUB-COUNT_REF for referencing the sub-count_ref is set to 70 in step S208. The SUB-COUNT_REF lies between zero and the maximum main count of the main counter (90).

For simplicity, when the regular time intervals for measuring BER are set to 1 second say, step S209 is repeated by a loop for 1 second, so that at every 1 second BER is measured in step S210. The measurement is done by the CPU 27 by reading out the value of a particular register of the demodulator 3. In the example shown in FIG. 6, step S209 is looped back to itself, but the loop can be substituted for by appropriate timer interrupts.

In step S211, the value of BER obtained in step S210 is classified to obtain corresponding two BER factors K1 and K2. For example, when the reception condition is favorable and the Viterbi-decoded signal has BER equal to 3e−6, then K1=1 and K2=5. But when the reception condition is not so good that BER is equal to 9e−4, then K1=−50 and K2=−25. The factors K1 and K2 obtained in step S211 are added to the respective counts of the main counter and sub-counter in step S212.

Steps S213 through S216 are operations of the sub-counter (second counter) to set the counter to the smallest possible value of zero (step S214) if the count becomes less than zero (step S213) when the BER is added thereto in step S212, or set the count to the maximum sub-count (step S216) if the resultant count exceeds the limit (step S215).

Next, in step S217, it is determined whether the count of the main counter (first counter) is less than zero. If it is, it implies that the reception status has become worse. The procedure then proceeds to step S218, where it is checked whether the current layer is the 12-seg layer with the 12-seg flag set to 1. If it is, the CPU 27 switches the data selection switches 15 and 16 to the respective second audio decoder 11 and second video decoder 13 (e.g. H.264 decoder) in step S219, thereby presenting 1-seg video and audio on the display. Subsequently, the procedure reset the 12-seg flag to zero in step S220, and set the main count to the smallest possible value of zero, and returns to step S201. If the 12-seg flag is zero (step S218), it implies that the currently presented data belongs to the 1-seg layer, so that no switching is made. The procedure then sets the count of the main counter to zero and returns to step S201.

On the other hand, if the main count is greater than zero (step 217), the procedure proceeds to step S222, where a determination is made as to whether the main count has exceeded its allowable largest count (referred to as maximum main count). When the main count has not exceeded the maximum main count, the procedure proceeds to step S223 to check if the main count exceeds the SUB-COUNT_REF set in step S208. When the count has not exceeded the SUB-COUNT_REF, the procedure returns to step S201, but otherwise proceeds to step S224 to reference the sub-count. If the sub-count has reached its largest allowable count (referred to as maximum sub-count), the procedure proceeds to step S225 to find which layer is currently presented. If it is the 1-seg layer, the receiver is switched to the 12-seg layer in step S226 without waiting for the main count to reach the maximum main count, sets the 12-seg flag to 1 in step S227, and returns to step S201. Thus, the switching of the receiver from the 1-seg layer to the 12-seg layer can be done quickly when the reception status is improving.

In step S223, when the main count has not exceeded the SUB-COUNT_REF, or when the main count has exceeded the SUB-COUNT_REF but the sub-count has not reached its maximum sub-count, the procedure simply returns to step S201 without executing anything. If the main count has exceeded the maximum main count in step S222, the procedure proceeds to step S231 to set the main counter to the largest possible value, or maximum main count thereof, without performing switching in steps S229 and 230, provided that the 12-seg flag is set to 1 and the 12-seg layer has been presented in step S228. Then the procedure returns to step S201.

As shown in FIG. 4 and described above, the main count is not set to the largest possible value when the main count has not exceeded its maximum main count (step S222) but the 1-seg layer is switched over to the 12-seg layer upon reference to the sub-count (steps S223 through S227). However, if the main count then need be set to the maximum main count, the procedure may be advanced to step S228 provided that the sub-count has reached its maximum sub-count. In this case, steps S225 through S227 can be omitted.

It is also noted that the receiver described in the preceding examples are advantageously provided with two sets of audio and video decoders to simultaneously decode video and audio data on the two layers. This configuration enable switching of the layers with a minimum delay. On the other hand, if the receiver is provided with only one decoder and adapted to select data to be inputted in the decoder, the cost of the receiver can be reduced.

Although in the example shown and described above a lookup table is used to classify the values of measured BER and give associated BER factors, classification of measured BER and assignment of BER factors thereto can be made by a function.

It is noted that an OSD (On-Screen Display) circuit may be provided between the video data selection switch 16 and the NTSC encoder 20 to conveniently display characters and draw pictures on a display screen.

1. A digital broadcasting receiver having switching means for switching the receiver between different received layers of a broadcast channel transmitting a digital broadcast program on the layers, based on the reception status of the layers, the receiver comprising:
either at least one lookup table of positive and negative weighted BER factors each assigned to a predetermined range of classified BER of a receivable broadcast signal or a function for giving the weighted BER factors;
at least one counter adapted to add up the weighted BER factors that are found by the lookup table and/or the function in correspondence with the measured values of BER of a received broadcast signal as measured at predetermined time intervals;
control means for controlling the switching means based on the count of the counter,
thereby generating appropriate switching timing for the switching means.

2. The digital broadcasting receiver according to claim 1, wherein
the allowable maximum count for the counter is preliminarily set in the lookup table, and wherein
the control means is adapted to:
measure the BER at predetermined time intervals;
add to the count the BER factor associated with the value of BER measured and;
reset the count to zero if the count becomes less than zero when the factor is added to the count, and perform switching from one layer to another only if the latest layer is not the same as the layer that would be presented by the switching; and
hold the count to the allowable maximum count if the count exceeds the allowable maximum count when the factor is added to the count, and perform switching from one layer to another only if the latest layer is not the same as the layer that would be presented by the switching.

3. The digital broadcasting receiver according to claim 1, wherein the lookup table contains at least one BER factor of zero between positive and negative BER factors.

4. The digital broadcasting receiver according to claim 2, wherein the initial value of the counter is set to a value less than the allowable maximum count.

5. The digital broadcasting receiver according to claim 2, comprising a multiplicity of counters as defined in claim 1 that operate in parallel to each other in association with a lookup table of classified BER factors having an allowable maximum count, wherein the control means is adapted to switch the layers when the count of a particular one of the multiple counters has exceeded a predetermined value and when the count of another counter satisfies a predetermined criterion.

6. The digital broadcasting receiver according to claim 2, comprising a multiplicity of counters as defined in claim 1 and a multiplicity of different lookup table of weighted BER factors having different allowable maximum counts and associated with the respective counters, wherein a preferred one of the lookup tables is selectable for a preferred mode of switching of the layers.

7. The digital broadcasting receiver according to claim 2, wherein
a minimum holding time is defined to hold the current layer as it is prior to switching, based on a relationship between the period of measurement of BER, the allowable maximum count, and the minimum and maximum BER factors of the lookup table; and
the absolute value of the quotient obtained by dividing the allowable maximum count by the minimum BER factor is greater than the quotient obtained by dividing the allowable maximum count by the maximum BER factor.

8. The digital broadcasting receiver according to claim 2, wherein the lookup table contains at least one BER factor of zero between positive and negative BER factors.

9. The digital broadcasting receiver according to claim 4, comprising a multiplicity of counters as defined in claim 1 that operate in parallel to each other in association with a lookup table of classified BER factors having an allowable maximum count, wherein the control means is adapted to switch the layers when the count of a particular one of the multiple counters has exceeded a predetermined value and when the count of another counter satisfies a predetermined criterion.

10. The digital broadcasting receiver according to claim 4, comprising a multiplicity of counters as defined in claim 1 and a multiplicity of different lookup table of weighted BER factors having different allowable maximum counts and associated with the respective counters, wherein a preferred one of the lookup tables is selectable for a preferred mode of switching of the layers.

11. The digital broadcasting receiver according to claim 4, wherein
a minimum holding time is defined to hold the current layer as it is prior to switching, based on a relationship between the period of measurement of BER, the allowable maximum count, and the minimum and maximum BER factors of the lookup table; and
the absolute value of the quotient obtained by dividing the allowable maximum count by the minimum BER factor is greater than the quotient obtained by dividing the allowable maximum count by the maximum BER factor.

12. The digital broadcasting receiver according to claim 4, wherein the lookup table contains at least one BER factor of zero between positive and negative BER factors.

13. The digital broadcasting receiver according to claim 5, comprising a multiplicity of counters as defined in claim 1 and a multiplicity of different lookup table of weighted BER factors having different allowable maximum counts and associated with the respective counters, wherein a preferred one of the lookup tables is selectable for a preferred mode of switching of the layers.

14. The digital broadcasting receiver according to claim 6, wherein
a minimum holding time is defined to hold the current layer as it is prior to switching, based on a relationship between the period of measurement of BER, the allowable maximum count, and the minimum and maximum BER factors of the lookup table; and
the absolute value of the quotient obtained by dividing the allowable maximum count by the minimum BER factor is greater than the quotient obtained by dividing the allowable maximum count by the maximum BER factor.

15. The digital broadcasting receiver according to claim 7, wherein the lookup table contains at least one BER factor of zero between positive and negative BER factors.

16. The digital broadcasting receiver according to claim 9, comprising a multiplicity of counters as defined in claim 1 and a multiplicity of different lookup table of weighted BER factors having different allowable maximum counts and associated with the respective counters, wherein a preferred one of the lookup tables is selectable for a preferred mode of switching of the layers.

17. The digital broadcasting receiver according to claim 9, wherein
a minimum holding time is defined to hold the current layer as it is prior to switching, based on a relationship between the period of measurement of BER, the allowable maximum count, and the minimum and maximum BER factors of the lookup table; and
the absolute value of the quotient obtained by dividing the allowable maximum count by the minimum BER factor is greater than the quotient obtained by dividing the allowable maximum count by the maximum BER factor.

18. The digital broadcasting receiver according to claim 9, wherein the lookup table contains at least one BER factor of zero between positive and negative BER factors.

19. The digital broadcasting receiver according to claim 10, wherein
a minimum holding time is defined to hold the current layer as it is prior to switching, based on a relationship between the period of measurement of BER, the allowable maximum count, and the minimum and maximum BER factors of the lookup table; and
the absolute value of the quotient obtained by dividing the allowable maximum count by the minimum BER factor is greater than the quotient obtained by dividing the allowable maximum count by the maximum BER factor.

20. The digital broadcasting receiver according to claim 11, wherein the lookup table contains at least one BER factor of zero between positive and negative BER factors.

21. The digital broadcasting receiver according to claim 13, wherein
a minimum holding time is defined to hold the current layer as it is prior to switching, based on a relationship between the period of measurement of BER, the allowable maximum count, and the minimum and maximum BER factors of the lookup table; and
the absolute value of the quotient obtained by dividing the allowable maximum count by the minimum BER factor is greater than the quotient obtained by dividing the allowable maximum count by the maximum BER factor.

22. The digital broadcasting receiver according to claim 14, wherein the lookup table contains at least one BER factor of zero between positive and negative BER factors.

23. The digital broadcasting receiver according to claim 16, wherein
a minimum holding time is defined to hold the current layer as it is prior to switching, based on a relationship between the period of measurement of BER, the allowable maximum count, and the minimum and maximum BER factors of the lookup table; and
the absolute value of the quotient obtained by dividing the allowable maximum count by the minimum BER factor is greater than the quotient obtained by dividing the allowable maximum count by the maximum BER factor.

24. The digital broadcasting receiver according to claim 16, wherein the lookup table contains at least one BER factor of zero between positive and negative BER factors.

25. The digital broadcasting receiver according to claim 17, wherein the lookup table contains at least one BER factor of zero between positive and negative BER factors.

26. The digital broadcasting receiver according to claim 19, wherein the lookup table contains at least one BER factor of zero between positive and negative BER factors.

27. The digital broadcasting receiver according to claim 21, wherein the lookup table contains at least one BER factor of zero between positive and negative BER factors.

28. The digital broadcasting receiver according to claim 23, wherein the lookup table contains at least one BER factor of zero between positive and negative BER factors.
